(19) United States
(12) Patent Application Publication
(10) Pub. No.: US 2026/0049670 A1
(43) Pub. Date: Feb. 19, 2026

(54) Coil Retention Apparatus Having L-Bracket Fingers

(71) Applicants: Michael J. Koch, Schaumburg, IL (US); Shane Duncan Bartow, Streamwood, IL (US); Zhe Shen, Palatine, IL (US); James E. Pearson, Downers Grove, IL (US)

(72) Inventors: Michael J. Koch, Schaumburg, IL (US); Shane Duncan Bartow, Streamwood, IL (US); Zhe Shen, Palatine, IL (US); James E. Pearson, Downers Grove, IL (US)

(73) Assignee: Robertshaw Controls Company, Itasca, IL (US)

(21) Appl. No.: 19/250,512

(22) Filed: Jun. 26, 2025

Related U.S. Application Data
(60) Provisional application No. 63/684,602, filed on Aug. 19, 2024.

(51) Int. Cl. F16K 31/06; F16K 27/02

(52) U.S. Cl. CPC F16K 31/06; F16K 27/029

(57) ABSTRACT

A solenoid coil retention assembly attaches a solenoid coil to a guide tube. The guide tube attached to a valve body of a pilot operated water valve. The solenoid coil retention assembly includes a first bracket that defines a first mounting portion. A second bracket includes a second mounting portion. The first mounting bracket is joined to the second mounting bracket forming a frame that is a magnetic path surrounding the solenoid coil. The first mounting portion includes a first plurality of disruptions, and the second mounting portion includes a second plurality of disruptions.

### CROSS-REFERENCE TO RELATED PATENT APPLICATIONS

This patent application claims the benefit of U.S. Provisional Ser. No. 63/684,602 , filed Aug. 19, 2024, the entire teachings and disclosure of which are incorporated herein by reference thereto.

### FIELD OF THE INVENTION

This invention generally relates to solenoid operated valves, and more particularly to an apparatus for connecting a frame surrounding a solenoid coil to a guide tube attached to a valve body of a pilot operated water valve.

### BACKGROUND OF THE INVENTION

A pilot operated water valve utilizes a solenoid that surrounds a guide tube having a plunger therein. The guide tube is attached to the valve body of the water valve. The solenoid is used to move a plunger to open a small pilot valve having a small pilot opening in the valving section. When opened, this pilot valve allows a small amount of water to flow and open a diaphragm using the principle of differential pressure and surface area. The diaphragm then opens the main valving member that controls the main flow of the process fluid.

Attachment mechanisms for attaching a solenoid coil assembly to a valve body and valves incorporating the solenoid coil assembly are described in U.S. Pat. No. 10,544,874, “Coil capture apparatus and pilot operated water valve incorporating same,” the entire disclosure of which is incorporated herein by reference thereto. Such mechanisms can include weld rings attached to the valve body that have locking tabs to engage and hold the solenoid coil assembly. Two or more locking tabs are used. Inclusion of locking tab receiving locations on the solenoid coil frame or configuration of the end surface of the solenoid frame itself accommodate the locking tabs. The weld ring may be attached in an infinite number of orientations on the valve body. Attachment may be by spin welding or ultrasonic welding of the weld ring to the valve body in two embodiments. While this design is effective, use of the weld ring introduces a new part that drives up production costs. Moreover, the locking tabs during the welding process may break or crack.

PRIOR ART FIG. 6 illustrates a pilot operated water valve 600 having yet another means by which a solenoid coil assembly 602 is attached to the valve body 604 of the pilot operated water valve 600. The solenoid coil assembly 602 includes a solenoid coil frame 606 and an encapsulated solenoid 608. A guide tube 610 is welded to the valve body 604. The guide tube 610 includes vertical walls 612, 614. The vertical walls 612, 614 have receiving apertures 616 that receive tabs 618 of the encapsulated solenoid 608 to provide a snap fit attachment of the guide tube 610 to the solenoid coil assembly 602.

While the designs described above have proven to be effective, unfortunately, at times, the vertical walls, 612, 614 crack and break off during the ultrasonic welding process that welds the guide tube 610 to the valve body. This damage increases production costs because the damaged valve must be discarded, or the vertical walls of the damaged valves must be repaired. Either possibility slows production time and requires more material in further production of another valve or repaired valve. Still further, if the cracks are not discovered, then in operation, the pilot water valves that cracked during the welding process are likely to be defective with decreased life expectancy or premature failure as the solenoid coil assembly separates from the guide tube and in turn the valve body.

Accordingly, what is needed is an improved solenoid coil retention assembly for attaching solenoid coil assemblies to a guide tube attached to a valve body.

### BRIEF SUMMARY OF THE INVENTION

The invention provides such a solenoid coil assembly for attachment to a guide tube, the guide tube attached to a valve body of a pilot operated water valve. The solenoid coil assembly solves the problem associated with use of vertical walls on the guide tube that crack or break during assembly, namely when the guide tube is welded to the valve body. Because the vertical walls are not needed with this design, then production costs for the water valve are reduced. Moreover, the solenoid coil assembly of the instant application efficiently and effectively attaches to the guide tube attached to a valve body of the pilot operated water valve. These and other advantages of the invention, as well as additional inventive features, will be apparent from the description of the invention provided herein.

In one aspect, the invention provides a solenoid coil retention assembly attaching a solenoid coil to a guide tube. The guide tube is attached to a valve body of a pilot operated water valve. The solenoid coil retention assembly includes a first bracket comprising a first mounting portion. A second bracket includes a second mounting portion.

The first mounting bracket joined to the second mounting bracket form a frame surrounding the solenoid coil. The first mounting portion includes a first plurality of disruptions, and the second mounting portion includes a second plurality of disruptions.

In an embodiment, the first mounting portion is a sleeve defined by a first leg of the first bracket.

In an embodiment, the first sleeve has a first end defining a through opening in the first leg and a second end opposite the first end. The second end located radially inward of the first leg and inside the frame.

In an embodiment, the first plurality of disruptions is located nearer the second end than the first end of the sleeve.

In an embodiment, the second end is a tapered end.

In an embodiment, the first plurality of disruptions is located on the tapered end.

In an embodiment, each one of the first plurality of disruptions is evenly spaced apart from one another around the tapered end.

In an embodiment, the first plurality of disruptions comprises three disruptions that are crescent shaped protrusions that extend radially inwardly toward a center axis that is defined by the sleeve. The center axis extends longitudinally through the sleeve.

In an embodiment, the first plurality of disruptions define an innermost diameter of the first sleeve.

In an embodiment, the innermost diameter of the first end is greater than the innermost diameter of the second end.

In an embodiment, the first bracket and the second bracket are identical L-shaped brackets.

In another aspect, the invention provides a pilot operated water valve that includes a valve body and aa solenoid coil retention assembly. The solenoid coil retention assembly includes a frame surrounding an encapsulated solenoid. The pilot operated water valve includes a guide tube attached to the valve body. The guide tube extends through the encapsulated solenoid. Disruptions on the frame at least partially penetrate an outermost surface of the guide tube to attach the solenoid coil assembly to the guide tube.

In an embodiment, the frame includes a first bracket defining a sleeve that defines a first through-hole. A second bracket defines another sleeve that defines a second through-hole. The guide tube extends through the first through-hole and the second through-hole.

In an embodiment, the sleeve includes at least a portion of the disruptions and the another sleeve includes another portion of the disruptions.

In an embodiment, the guide tube is of plastic material and the frame is of metal.

In an embodiment, the distortions are crescent shaped.

In an embodiment, the encapsulated solenoid defines a through-hole extending completely through the encapsulated solenoid. A first end of the through-hole receives the sleeve of the first bracket therein and a second end of the through-hole receives the another sleeve of the second bracket therein.

In an embodiment, the guide tube extends from the valve body in a tapered profile.

In an embodiment, the guide tube has between 4 and 5 degrees of taper in extension from a base of the guide tube to an end of the guide tube opposite the base.

In an embodiment, the sleeve and the another sleeve each include a tapered portion that includes at least a portion of the distortions.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a pilot operated water valve according to the teachings of the instant invention;

FIG. 2 is a partial cross section take about line 2-2 of the pilot operated water valve of FIG. 1;

FIG. 3 illustrates a frame of a solenoid coil retention assembly with an encapsulated coil of the assembly removed from the pilot operated water valve of FIG. 1;

FIG. 4 illustrates the first L bracket of the frame of the solenoid coil retention assembly of the pilot operated water valve of FIG. 1

FIG. 5 illustrates disruptions of the first L bracket at least partially penetrating a guide tube of the pilot operated water valve of FIG. 1;

FIG. 6 illustrates a prior art pilot operated water valve.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

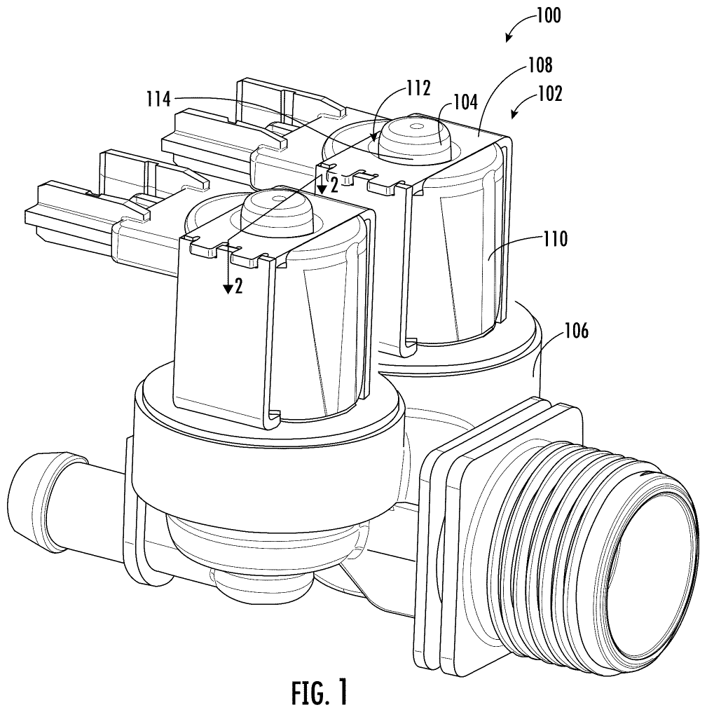

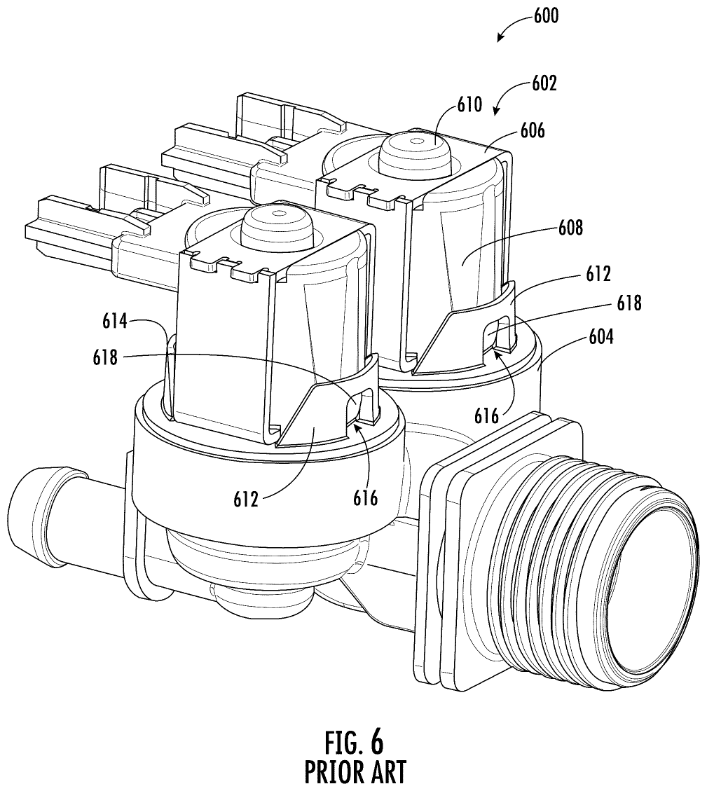

FIG. 1 illustrates a pilot operated water valve 100 according to the instant invention. The pilot operated water valve 100 does not include vertical walls 612, 614 (FIG. 6) to retain its solenoid coil retention assembly 102. Thus, pilot water operated valve 100 is an improvement over pilot operated water 600 (FIG. 6) because there are no vertical walls 612, 614 (FIG. 6) to crack or break off as a guide tube 104 is welded to the valve body 106 of the pilot operated water valve 100.

The pilot operated water valve 100 includes the guide tube 104 that is attached, typically via weldment to the valve body 106. The pilot operated water valve 100 also includes the solenoid coil retention assembly 102. The solenoid coil retention assembly 102 includes a frame 108 that is metallic and is a magnetic loop that surrounds an encapsulated solenoid coil 110. The guide tube 104 extends through a through-hole 112 defined by the encapsulated solenoid 110 to mount the encapsulated solenoid 110 to the guide tube 104. The guide tube 104 has an outermost surface 114 made of plastic.

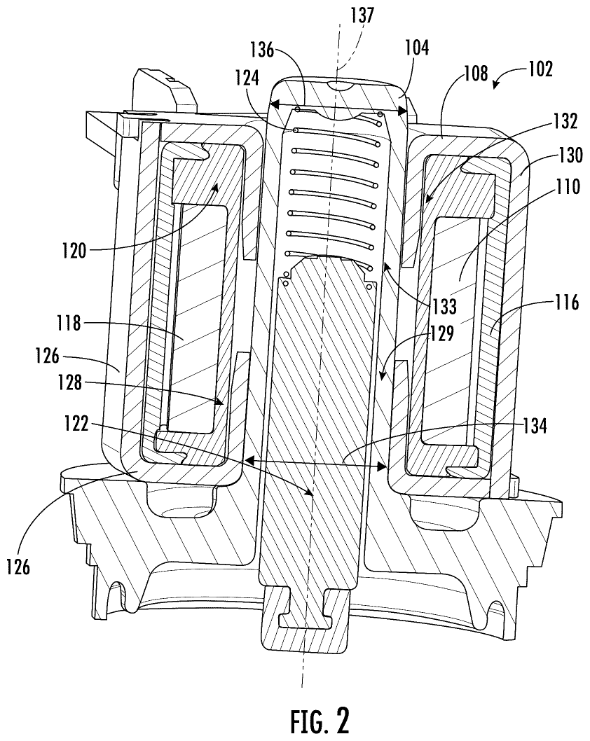

Turning to the partial cross section of FIG. 2, the frame 108 surrounds the encapsulated solenoid coil 110 and attaches to the guide tube 104 which in turn is attached, as described above to the valve body 106 (FIG. 1). An encapsulating material 116 that is non-conductive surrounds windings 118 wound about a bobbin 120. The guide tube 104 includes an armature 122 in the guide tube 104 and a biasing spring 124 to seat and unseat to close and open a small pilot opening (not illustrated) in the valving section (not illustrated).

The frame 108 includes a first bracket 126 that is L-shaped and defines a mounting portion 128 that is an annular sleeve that defines a first through-hole 129 for receiving the guide tube 104 therethrough. The frame 108 includes a second bracket 130 that is L-shaped and defines a second mounting portion 132 that is an annular sleeve that defines a second through-hole 133 for receiving the guide tube 104 therethrough. The guide tube 104 extends through the first through-hole 129 and the second through-hole 133 to mount the solenoid coil retention assembly 102 to the guide tube 104 which in turn is attached to the valve body 106 (FIG. 1).

The guide tube 104 at its base has a larger outer diameter 134 than an outer diameter 136 at its end opposite the base. Thus, the guide tube 104 is a tapered along its longitudinal length as it extends from the base to the end opposite the base. The taper may be between one (1) and five (5) degrees relative to the longitudinal center axis 137 defined by the guide tube 104. In a preferred embodiment the taper is five (5) degrees.

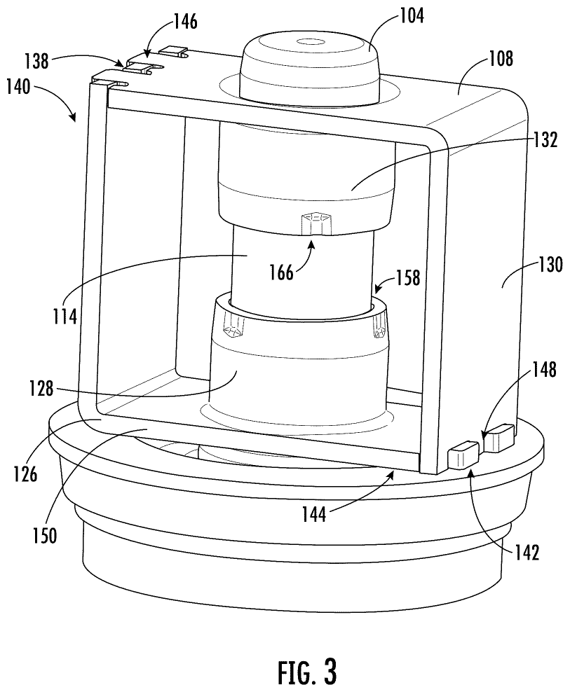

FIG. 3 illustrates the frame 108 that is metallic loop and which receives the guide tube 104 therethrough. The encapsulated solenoid coil 110 (FIG. 1) surrounded by the frame 108 is not shown to better illustrate the attachment of the guide tube 104 to the frame 108. As previously discussed, the frame 108 includes the first bracket 126 that is L-shaped. The first bracket 126 has a first set of fingers 138 at a first end 140 and a second set of fingers 142 at a second end 144 of the first bracket 126. The first set of fingers 138 and the second set of fingers 142 receiving cooperating fingers 146, 148 respectively from the second bracket 130 to form the frame 108. The first bracket 126 and the second bracket 130 are identical. Accordingly, that which is described with respect to the first bracket 126 applies to the second bracket 130 and therefore the structure of the second bracket 130 will not be described except as set forth below as it is the same as that of the first bracket 126.

The encapsulated solenoid coil 110 (FIG. 1) is pushed onto the first mounting portion 128 of the first bracket 126. The second mounting portion 132 of the second bracket 130 is then pushed into the encapsulated solenoid coil 110 (FIG. 1). The first bracket 126 and the second bracket 130 are joined at the fingers 138, 142, 146 and 148 to form the frame 108 surrounding the encapsulated solenoid coil 110. The first mounting portion 128 is a sleeve defined by a first leg 150 of the first bracket 126. The sleeve is integral with the first leg 150 and is not a separate piece that must be joined to the first leg 150.

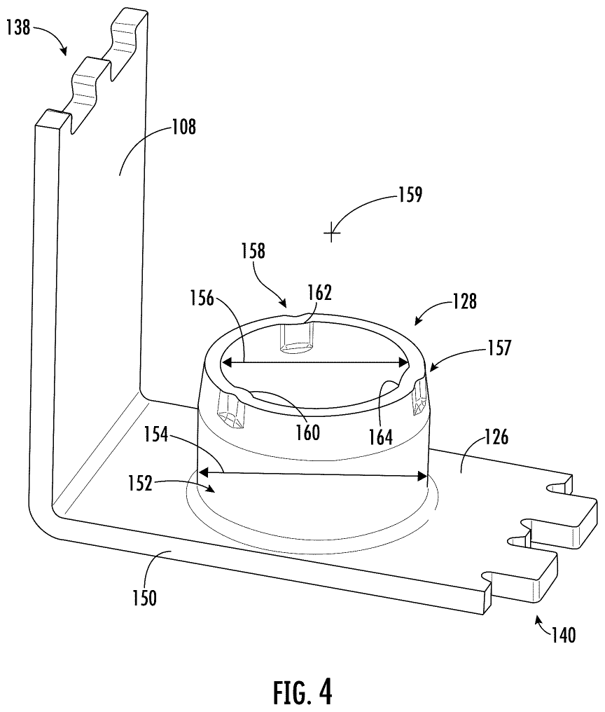

FIG. 4 illustrates the first bracket 126 having the first mounting portion 128 that is the sleeve. At an end portion 152 of the sleeve proximate the first leg 150, the innermost diameter 154 is greater than the innermost diameter 156 at the opposite end 157 of the sleeve that is located radially inward relative to the frame 108. By radially inward it is meant that the frame 108 defines a center axis 159 such that radially inward means in a direction towards the center axis 159 of the frame 108. Thus, the opposite end 157 is a tapered end portion of the sleeve. The opposite end 157 that is a tapered end portion surrounds the guide tube 104 and provides for a compressive force wherein the tapered end portion abuts the sleeve against the guide tube 104 when the guide tube 104 is inserted therethrough as seen for example in FIG. 2.

Still with respect to FIG. 4, the end portion 157 that is a tapered end portion includes a first plurality of disruptions 158. Thus, the first plurality of disruptions 158 are located nearer to the opposite end 157 than the end 152 of the sleeve. In a preferred embodiment there are three disruptions 160, 162, 164 that are equally spaced apart around the tapered end portion 157. Each of the first plurality of disruptions 158 are crescent shaped protrusions extending radially inward relative to the central longitudinal axis defined by the sleeve. While the first plurality of disruptions 158 illustrates three disruptions 160, 162, 164, in an embodiment there may be only one (1) disruption but in other embodiments there may be more than one disruption.

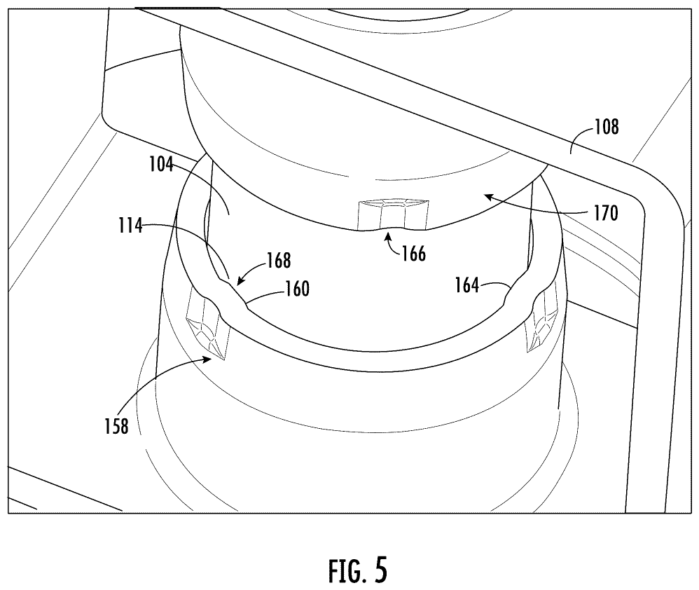

Turning to FIG. 5, each disruption 162, 164, 166 of the first plurality of disruptions 158 dig into the outer most surface 114 of the guide tube 104 when the frame 108 is pushed onto the guide tube 114. Each of the first plurality of disruptions 158 are analogous to one-way barbs that resist pull out more than the resist push on.

Returning to FIG. 3, as previously discussed, the first bracket 126 and the second bracket 130 are identical. Accordingly, that which is described with respect to the first bracket 126 applies to the second bracket 130 except for the mechanical forces relative to the guide tube 104 and the first plurality of disruptions 158 and a second plurality of disruptions 166 on the second mounting portion 132. That is, the second plurality of disruptions 166 of the second mounting portion 132 have less retention effect than the first plurality of disruptions 154 because of the taper on the guide tube 104 such that there is less penetration into the outermost surface 114 of the guide tube 104 because of the greater distance between the outermost surface of the guide tube 114 and the second plurality of disruptions 166.

Returning to FIG. 5, the retention effect of the second plurality of disruption 166 is also less than that of the first plurality of disruptions 158 because the first plurality of disruptions 158 must cross over and overcome the penetration 168 created in the outermost surface 114 of the guide tube 104. However, the second plurality of disruptions 166 does not need to cross over and overcome the penetration created in the outermost surface 114 of the guide tube 104 as forces move to slide the solenoid coil retention assembly 102 (FIG. 2) off the guide tube 104. Nevertheless, what retention is provided by the tapered end 170 with the second plurality of disruptions 166 aids in retaining the solenoid coil assembly 102 (FIG. 2) to the guide tube 104, but not to the degree provided by the first plurality of disruptions 158 that penetrate the guide tube 104.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A solenoid coil retention assembly attaching a solenoid coil to a guide tube, the guide tube attached to a valve body of a pilot operated water valve, the solenoid coil retention assembly comprising:
a first bracket comprising a first mounting portion;
a second bracket comprising a second mounting portion; the first mounting bracket joined to the second mounting bracket forming a frame surrounding the solenoid coil;
wherein the first mounting portion includes a first plurality of disruptions, and the second mounting portion includes a second plurality of disruptions.

2. The solenoid coil retention assembly of claim 1, wherein the first mounting portion is a sleeve defined by a first leg of the first bracket.

3. The solenoid coil assembly of claim 2, wherein the first sleeve has a first end defining a through opening in the first leg and a second end opposite the first end, the second end located radially inward of the first leg inside the frame.

4. The solenoid coil assembly of claim 3, wherein the first plurality of disruptions is located nearer the second end than the first end of the sleeve.

5. The solenoid coil assembly of claim 3, wherein the second end is a tapered end.

6. The solenoid coil assembly of claim 5, wherein the first plurality of disruptions is located on the tapered end.

7. The solenoid coil assembly of claim 1, wherein each one of the first plurality of disruptions is evenly spaced apart from one another one another around the tapered end.

8. The solenoid coil assembly of claim 7, wherein the first plurality of disruptions comprises three disruptions that are crescent shaped protrusions extending radially inwardly toward a center axis that is defined by the sleeve, the center axis extending longitudinally through the sleeve.

9. The solenoid assembly of claim 1, wherein the first plurality of disruptions defines an innermost diameter of the first sleeve.

10. The solenoid coil assembly of claim 3, wherein the innermost diameter of the first end is greater than the innermost diameter of the second end.

11. The solenoid coil assembly of claim 1 wherein the first bracket and the second bracket are identical L-shaped brackets.

12. A pilot operated water valve comprising:
a valve body;
a solenoid coil retention assembly comprising a frame surrounding an encapsulated solenoid;
a guide tube attached to the valve body; the guide tube extending through the encapsulated solenoid;
wherein disruptions on the frame at least partially penetrate an outermost surface of the guide tube to attach the solenoid coil assembly to the guide tube.

13. The pilot operated water valve of claim 12, wherein the frame includes a first bracket defining a sleeve that defines a first through-hole, a second bracket defining another sleeve that defines a second through-hole, the guide tube extending through the first through-hole and the second through-hole.

14. The pilot operated valve of claim 13, wherein the sleeve includes at least a portion of the disruptions and the another sleeve includes another portion of the disruptions.

15. The pilot operated valve of claim 12, wherein the guide tube is of plastic material and the wherein the frame is of metal.

16. The pilot operated water valve of claim 12, wherein the distortions are crescent shaped.

17. The pilot operated water valve of claim 14, wherein the encapsulated solenoid defines a through-hole extending completely through the encapsulated solenoid, a first end of the through-hole receives the sleeve of the first bracket therein and a second end of the through-hole receives the another sleeve of the second bracket therein.

18. The pilot operated water valve of claim 12, wherein the guide tube extends from the valve body in a tapered profile.

19. The pilot operated valve of claim 18, wherein the guide tube has between 4 and 5 degrees of taper in extension from a base of the guide tube to an end of the guide tube opposite the base.

20. The pilot operated valve of claim 14, wherein the sleeve and the another sleeve each include a tapered portion that includes at least a portion of the distortions.
